(19) United States
(12) Patent Application Publication
(10) Pub. No.: US 2023/0064797 A1
(43) Pub. Date: Mar. 2, 2023

(54) DISPLAY RENDERING OF NONLINEARLY SCALED 3D PARTS

(71) Applicant: Hewlett-Packard Development Company, L.P., Spring, TX (US)

(72) Inventors: Craig Peter Sayers, Palo Alto, CA (US); Artur Sampaio, Palo Alto, CA (US)

(73) Assignee: Hewlett-Packard Development Company, L.P., Spring, TX (US)

(21) Appl. No.: 17/793,962

(22) PCT Filed: Feb. 19, 2020
(86) PCT No.: PCT/US2020/018819

§ 371 Date: Jul. 20, 2022

(51) Int. Cl. B29C 64/386; B33Y 50/00; G05B 19/4099

(52) U.S. Cl. CPC B29C 64/386; B33Y 50/00; G05B 19/4099; G05B 2219/49023

(57) ABSTRACT

Systems and methods are described herein to display 3D part models with nonlinearly scaled bounding boxes and/or font sizes. The system may calculate display dimensions of a nonlinearly scaled bounding box as a nonlinear function of the print dimensions of a 3D part model. The system may additionally or alternatively select font sizes that are inversely proportional to the print dimensions of the 3D part model. The system may render a two-dimensional view of the 3D part model within the nonlinearly scaled bounding box for display on an electronic display. The system may also render the print dimensions of the 3D part model in the selected font size for display on the electronic display proximate the nonlinearly scaled bounding box.

### BACKGROUND

Designers may use a wide variety of computing devices, graphical user interfaces, and electronic displays to design, draw, and create three-dimensional parts for printing via a three-dimensional printer or other manufacturing processes. Computer-aided drafting software may allow for the rotation and resizing of three-dimensional parts within a graphical user interface. Various two-dimensional views of the three-dimensional part may be rendered for display within the graphical user interfaces.

Computer-aided drafting programs may allow for the design and visualization of parts of arbitrary sizes and shapes. Graphical user interfaces may include pan, rotate, and zoom features to view a given part from different angles and perspectives.

### BRIEF DESCRIPTION OF THE DRAWINGS

Non-limiting and non-exhaustive examples of the disclosure are described, including various examples of the disclosure, with reference to the figures described below.

FIG. 1A illustrates an example block diagram of a system to render a three-dimensional (3D) part model with a nonlinearly scaled bounding box.

FIG. 1B illustrates an example block diagram of a system to render the 3D part with a nonlinearly scaled bounding box with inverse, nonlinearly scaled dimension labeling.

FIG. 2 illustrates a graphical representation of the bounding box size output relative to an actual part size input for an example nonlinear function.

FIG. 3 illustrates a flow chart of an example method for rendering a 3D part model within a nonlinearly scaled bounding box.

FIG. 4 illustrates a graphical representation of the font size output relative to an actual part size for an example inverse, nonlinear function.

FIG. 5 illustrates a flow chart of an example method for rendering a 3D part model with a nonlinearly scaled bounding box and with inverse, nonlinearly scaled font sizes.

FIG. 6 illustrates an example graphical user interface with a relatively large 3D part model.

FIG. 7 illustrates an example graphical user interface with a relatively small 3D part model.

FIG. 8 illustrates an example graphical user interface with an oversized 3D part model.

### DETAILED DESCRIPTION

Various examples of systems and methods are described herein to display 3D part models with nonlinear bounding boxes. In some examples, 3D part model dimensions may be rendered proximate the nonlinear bounding boxes using inverse, nonlinear font sizes.

In various examples, a computing system may include a processor, memory, and storage system with instructions to be executed to implement the various operations, methods, and steps described herein. The system may provide a graphical user interface for visualizing 3D part models. The system may scale the 3D part model, an associated bounding box, and font sizes for displayed dimensions to provide an intuitive sense of scale. According to various examples, the system may utilize scaling functions that provide for the accurate assessment of part sizes within the print capabilities of an associated 3D printer. The system may also provide an intuitive sense of relative size for 3D part models that exceed the capabilities of the 3D printer.

The system may cache two-dimensional images of rendered 3D part models. The system may display a two-dimensional image of the 3D part model within a nonlinearly scaled bounding box. Dimensions of the 3D part model may be displayed using inverse, nonlinearly scaled font sizes.

The graphical user interfaces described herein may be incorporated into any of a wide variety of computer-aided drafting applications. Computer-aided drafting applications may be used to visualize 3D part models of arbitrary sizes ranging from, for example, an entire airplane to a tiny bolt. However, a selected 3D printer used in conjunction with the computer-aided drafting application can only print a finite range of 3D part model sizes. Parts which are too small can't be printed accurately because the printer lacks sufficient resolution, while parts which are too large may not fit inside the printer. In addition, larger printers tend to have lower resolutions and each printer has a range of part sizes for which it is best-suited. For example, one printer might be best-suited for parts between 2 cm and 20 cm, while a different printer might be better-suited for parts between 10 cm and 100 cm.

A computer-aided drafting application may display 3D part models within a graphical user interface using linear scaling. That is, 3D part models having smaller print dimensions are displayed smaller within a model display region of a graphical user interface, while 3D part models having larger print dimensions are displayed larger within the model display region of the graphical user interface. The scaling of the displayed 3D part models may be linear within a minimum display size and a maximum display size. In some examples, 3D part models may be displayed within the model display region of the graphical user interface such that the displayed part size corresponds to the print dimensions.

For example, a 3D part model having 1-centimeter print dimensions may appear on an electronic display with 1-centimeter display dimensions. With linear scaling, a 3D part model with 20-centimeter print dimensions may appear on the electronic display with 20-centimeter display dimensions. Linear scaling, as described above, gives a very accurate sense of part size but may make it difficult or impossible to visualize relatively large parts and relatively small parts. For example, small parts may be too small to see clearly on the electronic display, while large parts may not fit on the electronic display.

The presently described systems and methods allow for printer-dependent nonlinear scaling of 3D part models within nonlinearly scaled bounding boxes. For 3D printing applications, each printer has a range of part sizes for which it is best-suited. Accordingly, while the 3D part models displayed by a graphical user interface associated with a 3D printer may be of any size, only those within reasonable size limits are typically printed. The system may utilize reasonable part size bounds as variables in a nonlinear scaling function to provide both an intuitive sense of relative size for any 3D model and an accurate sense of absolute size for 3D part model sizes typically manufactured using the printing capabilities of the 3D printer.

In various examples, the system may display a two-dimensional image of a rendered 3D part model within a bounding box labeled with the print dimensions of the 3D part model. The system may determine dimensions for a nonlinearly scaled bounding box using a nonlinear function of the print dimensions of the 3D part model scaled to fit within a model display region of a graphical user interface.

A font size may be selected to display the print dimensions of the 3D part model. The font size may be selected inverse to the print dimensions of the 3D part model, such that relatively smaller font sizes are used with 3D part models having relatively larger print dimensions and relatively larger font sizes are used with 3D part models having relatively smaller print dimensions. The system may render a two-dimensional view of the 3D part model within the nonlinearly scaled bounding box with print dimensions of the 3D part model in the selected font size.

The system may utilize a nonlinear function to determine the display dimensions of bounding boxes for 3D part models having print dimensions outside of the print range of an associated 3D printer. The system may utilize a linear or approximately linear function to determine the display dimensions for 3D part models having print dimensions between the minimum and maximum print size ranges of the 3D printer.

The display dimensions of the nonlinearly scaled bounding box may be calculated as a nonlinear function of the print dimensions of a given 3D part model and scaled to fit within a model display region of a graphical user interface of a particular electronic display. For instance, the absolute dimensions of the displayed bounding box and 3D part model may depend on the size of the electronic display in use. The system may generate or select a two-dimensional view of the 3D part model from a perspective corresponding to an estimated viewing angle of an operator of a 3D printer viewing a printed version of the 3D part model printed on a print bed of the 3D printer.

The system may display print dimensions proximate the nonlinearly scaled bounding box in a font size that is inverse and nonlinearly scaled with respect to the print dimensions of the 3D part model. The font size may be linearly scaled or even the same size for 3D part models within the print capabilities of a 3D printer. For example, the system may select a “normal” or “standard” font size for 3D part models within the print capabilities of a 3D printer. The “normal” or “standard” font size may be, for example, the font size selected by a web browser to display a text field. Examples of a “normal” or “standard” font size include 10-, 12-, or 14-point font sizes.

The system may select font sizes using an inverse, nonlinear scaling function for 3D part models that are smaller than a typical minimum print size or larger than a typical maximum print size. The typical minimum and maximum print sizes for a given 3D printer may be based on the print bed size of the 3D printer, computed as a function of a minimum printable feature size, derived from data identifying the range of part sizes for which the printer is best-suited, and/or historical data identifying the typical range of print jobs executed by the 3D printer. Accordingly, the term “typical” to describe minimum and maximum print sizes may be based on or correspond to the practical, historical, or technological limitations of a given 3D printer.

In some examples, typical minimum and maximum print sizes may be based on historical 3D-printer usage and/or 3D-printer statistics and be referred to as “experienced typical” minimum and maximum print sizes or alternatively “experienced” minimum and maximum print sizes. Accordingly, various examples of the systems and methods described herein may utilize different “typical” minimum and maximum print sizes based on a selected or connected printer model.

In one example, a typical minimum print size is equal to the largest print size that is smaller than a defined percentage (e.g., 95%, 90%, 80%, 75%, etc.) of 3D parts previously printed by an associated 3D printer. Similarly, a typical maximum print size is equal to a smallest print size that is larger than a defined percentage (e.g., 95%, 90%, 80%, 75%, etc.) of 3D parts previously printed by the associated 3D printer. In some examples, the typical minimum print size may be defined as a function of the minimum feature size capable of being printed by a given 3D printer. In some examples, the typical maximum print size may be defined as a function of the printer bed size of the 3D printer.

In some cases, well-known features, structures, or operations are not shown or described in detail. Furthermore, the described features, structures, or operations may be combined in any suitable manner in various examples. It will also be readily understood that the components of the examples as generally described and illustrated in the figures herein could be arranged and designed in a wide variety of different configurations. The systems and methods described herein display 3D part models with bounding boxes and font sizes that provide an immediate and intuitive sense of the print dimensions of the 3D part model. The largest variations in the display size of 3D part models are exhibited for 3D part models having print dimensions within the print range of a 3D printer, while relatively small variations in the display size of 3D part models are exhibited for 3D part models having print dimensions outside the print range of a 3D printer.

For example, the variation in display size for 3D part model between 5 centimeters and 20 centimeters may be relatively large compared to the variation in display size for 3D part models between 1 meter and 10 meters. The font sizes selected inverse to the print dimensions of a 3D part model provide a sense of scale with respect to a displayed 3D part model. The two-dimensional perspective of the 3D part model can be displayed immediately to provide visual scale context while the 3D part model is fully rendered to allow for user panning, rotating, and zooming.

Some aspects of the systems and methods described herein may be implemented as computer-executable instructions (e.g., software), electronic circuitry and components (e.g., hardware), firmware, and/or combinations thereof. As used herein, a software module or component may include computer instructions or computer-executable code located within a memory device and/or transmitted as electronic signals over a system bus, wired network, or wireless network. A software module or component may, for instance, comprise multiple physical or logical blocks of computer instructions, which may be organized as a routine, program, object, component, data structure, etc., that performs tasks or implements particular data types.

Examples may be provided as a computer program product, including a non-transitory computer and/or machine-readable medium having stored thereon instructions that may be used to program a computer or another electronic device to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of machine-readable media suitable for storing electronic and/or processor-executable instructions.

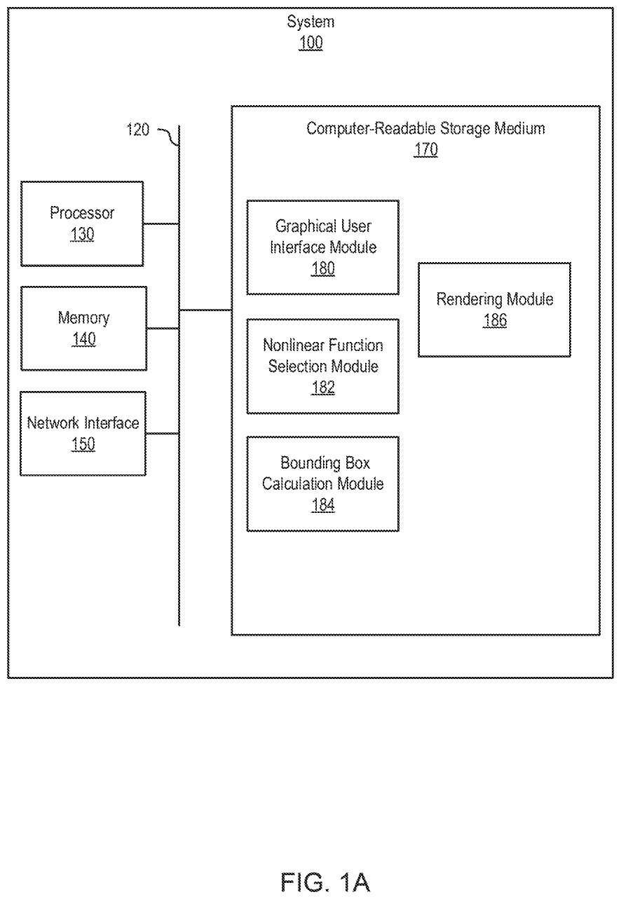

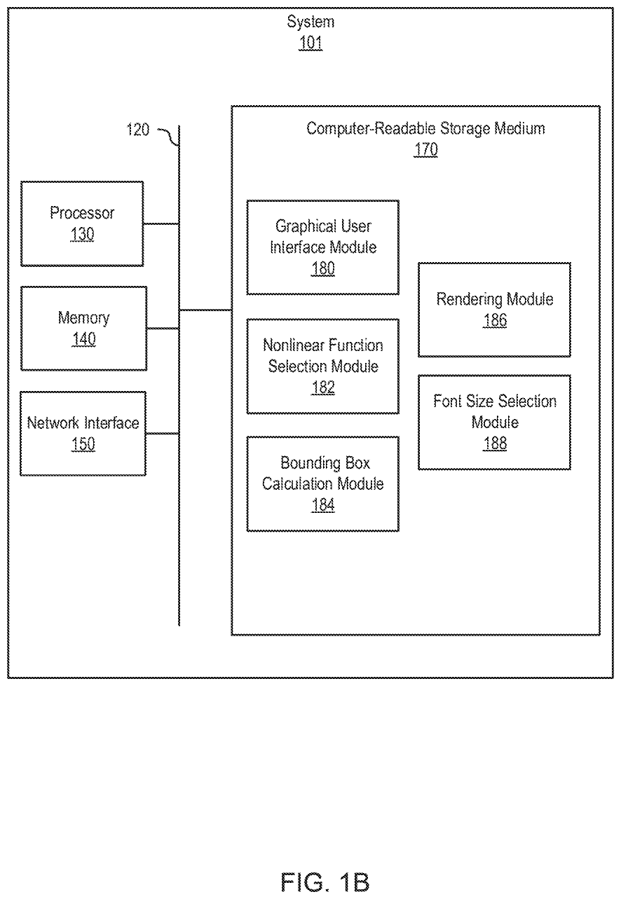

FIG. 1A illustrates an example block diagram of a system 100 to render a 3D part with a nonlinearly scaled bounding box. As illustrated, the system 100 may include a processor 130, memory 140, a network interface 150, and a computer-readable storage medium 170 connected to one another via a communication bus 120. The computer-readable storage medium 170 may be, for example, a non-transitory computer-readable storage medium 170. Instructions in the computer-readable storage medium 170 may be executable by the processor 130 and divided (physically or conceptually) into modules or submodules.

As illustrated, the system may include a graphical user interface module 180 to generate a graphical user interface to render a 3D part model for display within a model display region. A nonlinear function selection module 182 may access a stored nonlinear function, select a nonlinear function from a database of nonlinear functions, or receive user-specified parameters for a nonlinear function. In some examples, the nonlinear function selection module 182 may customize a stored nonlinear function based on a detected electronic display and/or parameters and settings of a web browser application. In some examples, the A nonlinear function selection module 182 may access a database of stored nonlinear functions that are automatically selected based on a detected electronic display, detected web browser settings, detected computer-aided drafting software settings, detected 3D printer capabilities, and/or other system settings. In some examples, the A nonlinear function selection module 182 may receive parameters for a nonlinear function from a user.

A bounding box calculation module 184 may calculate display dimensions for a nonlinearly scaled bounding box for the 3D part model based on the print dimensions of the 3D part model. According to various possible combinations of the examples described herein, the bounding box calculation module 184 may calculate display dimensions of the nonlinearly scaled bounding box based on a nonlinear function of the print dimensions of the 3D part model, scaled to fit within a model display region of a detected graphical user interface.

A rendering module 186 may render a two-dimensional view of the 3D part model within the nonlinearly scaled bounding box. The rendered two-dimensional view of the 3D part model may be displayed in a model display region of a graphical user interface on an electronic display. In some examples, the two-dimensional view of the 3D part model may be displayed within a region of a web browser, a stand-alone computer-aided drafting program, a browser-based computer-aided drafting program, or a browser-based 3D part visualization program (e.g., browser-based 3D-printing software).

In some examples, the rendering module 186 may render a two-dimensional view of the 3D part model from a perspective corresponding to an estimated viewing angle of an operator of a 3D printer viewing the same 3D part model printed on a print bed of the 3D printer. For example, the two-dimensional view of the 3D-part model may be from a perspective corresponding to the viewing angle of an operator at a control panel of a 3D printer.

FIG. 1 B illustrates an example block diagram of a system 101 similar to the system described in conjunction with FIG. 1A, but with an additional font size selection module 188. The font size selection module 188 may select (e.g., calculate or otherwise determine) a font size that is inversely related to the print dimensions of the 3D part model. Accordingly, the font size selection module 188 selects relatively small font sizes for 3D part models that have relatively large print dimensions and relatively large font sizes for 3D part models that have relatively small print dimensions.

The rendering module 186 may render the two-dimensional view of the 3D part model within the bounding box calculated by the bounding box calculation module 184, as described herein. Additionally, the rendering module 186 of system 101 may further render the print dimensions of the 3D part model for display proximate the bounding box. As described herein, the font size selection module 188 may select a font size that is approximately constant or linear for 3D part models having print dimensions between a minimum print size capability of an associated 3D printer and a maximum print size capability of the associated 3D printer. The font size selection module 188 may use any number less than zero (0) as the scaling factor in an inverse linear function for calculating the font sizes for 3D part models having display dimensions between the minimum and maximum print size capabilities.

The font size selection module 188 may use a nonlinear scaling function that approaches the minimum font size for 3D part models having print dimensions that exceed the maximum print size capabilities of the associated 3D printer. The font size selection module 188 may also use a nonlinear scaling function that approaches the maximum font size for 3D part models having print dimensions that are less than the minimum print size capabilities of the associated 3D printer.

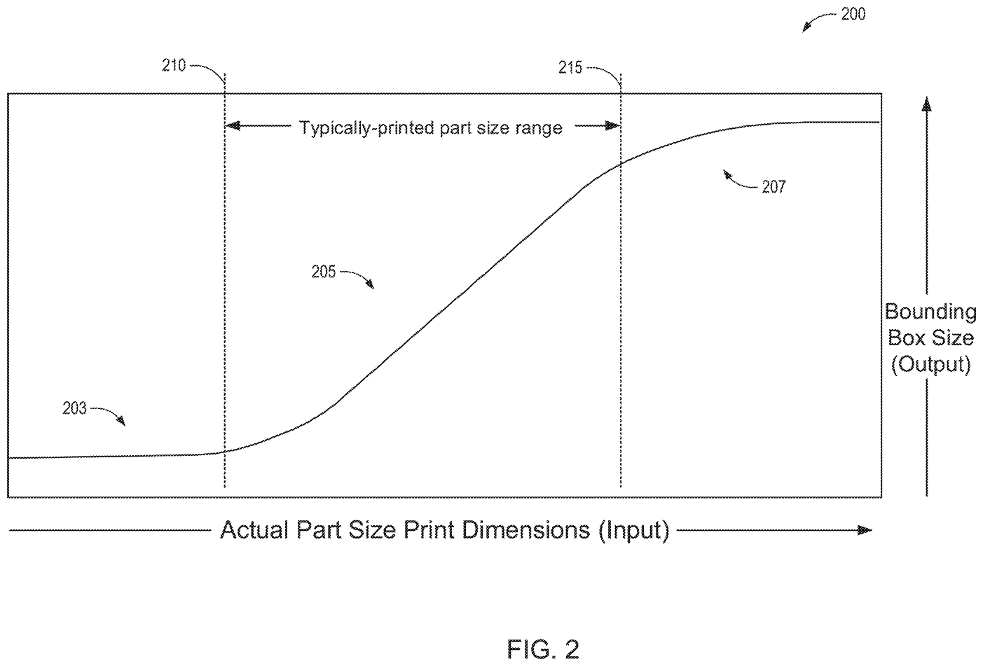

FIG. 2 illustrates a graphical representation 200 of the bounding box size output (vertical axis) relative to an actual part size input (horizontal axis) for an example nonlinear function. The example nonlinear function includes an approximately linear middle section 205 for 3D part models having print dimensions between a lower threshold value 210 and an upper threshold value 215. Section 205 of the nonlinear function is described as “approximately linear” because, as illustrated, of the nonlinear transition into a lower section 203 for 3D print models having print dimensions smaller than the lower threshold value 210 and the nonlinear transition into an upper section 207 for 3D print models having print dimensions larger than an upper threshold value 215.

The illustrated nonlinear function can be described as linearly scaled for at least a portion of the print dimensions between the minimum and maximum print size capabilities of an associated 3D Printer. The lower threshold value 210 and the upper threshold value 215 may correspond to or be equal to the minimum and maximum print size capabilities of the associated 3D Printer. As described herein, the system may utilize a nonlinear function, such as the illustrated graphical representation 200 of a nonlinear function, to determine display dimensions of a nonlinear bounding box.

Variations in the print dimensions of 3D part models within the lower threshold value 210 and the upper threshold value 215 (section 205) result in corresponding variations in the display dimensions of the nonlinear bounding box. In contrast, variations in the print dimensions of 3D part models smaller than the lower threshold value 210 (section 203) or greater than the upper threshold value 215 (section 207) result in relatively minor variations in the display dimensions of the nonlinear bounding box.

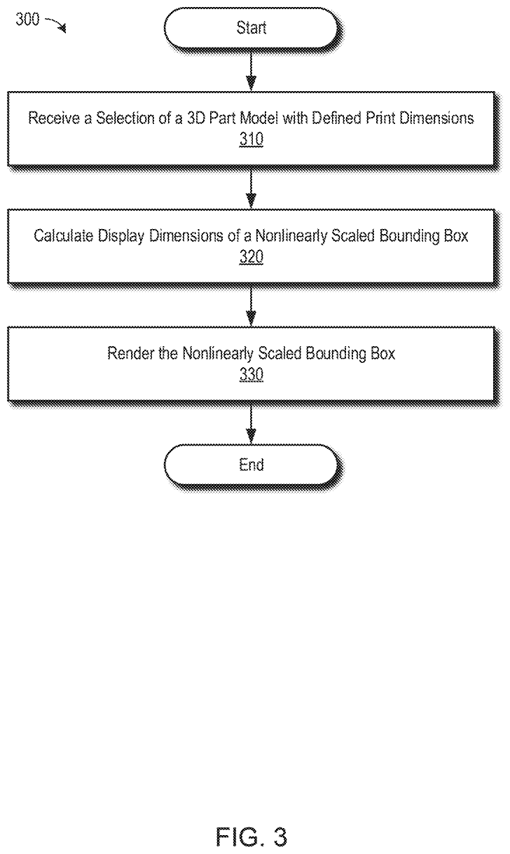

FIG. 3 illustrates a flow chart of an example method 300 for rendering a 3D part model within a nonlinearly scaled bounding box. As illustrated, a system may receive, at 310, a selection of a 3D part model with defined print dimensions. The print dimensions may, for example, define various length, width, and height values of portions of the nonlinearly scaled bounding box. In some examples, the print dimensions may define maximum length, width, and/or height values of the entire 3D part model.

The system may calculate, at 320, display dimensions of the nonlinearly scaled bounding box, according to any of the various examples described herein. The system may render, at 330, the nonlinearly scaled bounding box for display on an electronic display. A two-dimensional perspective view of the 3D part model may be scaled and displayed within the nonlinearly scaled bounding box.

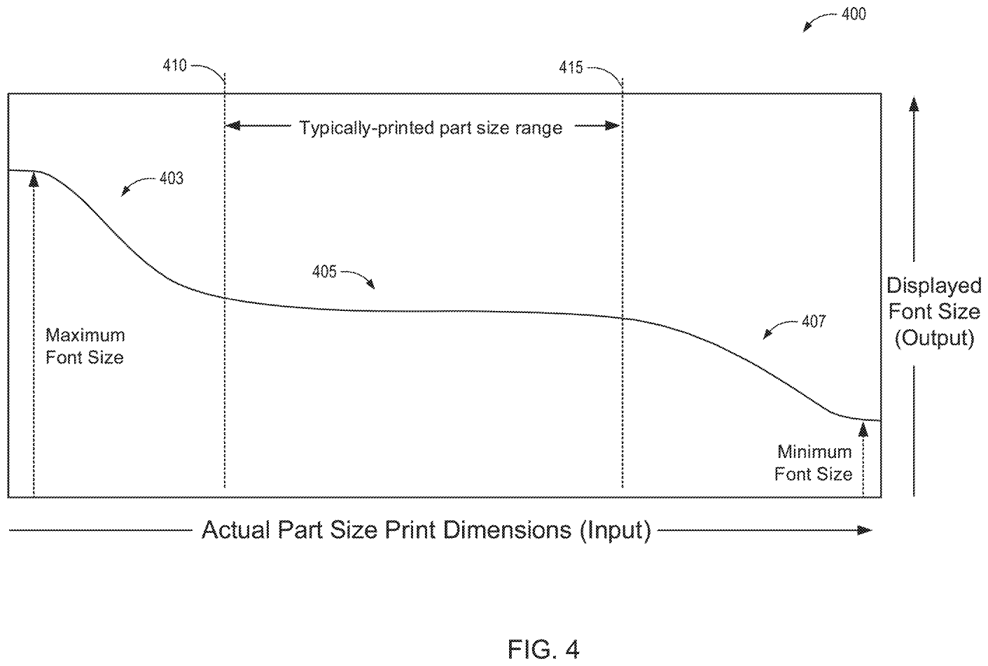

FIG. 4 illustrates a graphical representation 400 of the displayed font size output (vertical axis) relative to the actual part size print dimensions input (horizontal axis) for an example inverse, nonlinear function. The example inverse, nonlinear function includes a middle section 405 that maps a wide range of print dimensions to substantially the same font size. 3D part models that are smaller than a minimum threshold value 410 (e.g., a minimum print size for an associated 3D printer) are mapped to font sizes via the nonlinear section 403. Similarly, 3D part models that are larger than a maximum threshold value 415 (e.g., a maximum print size for an associated 3D printer) are mapped to font sizes via the nonlinear section 407.

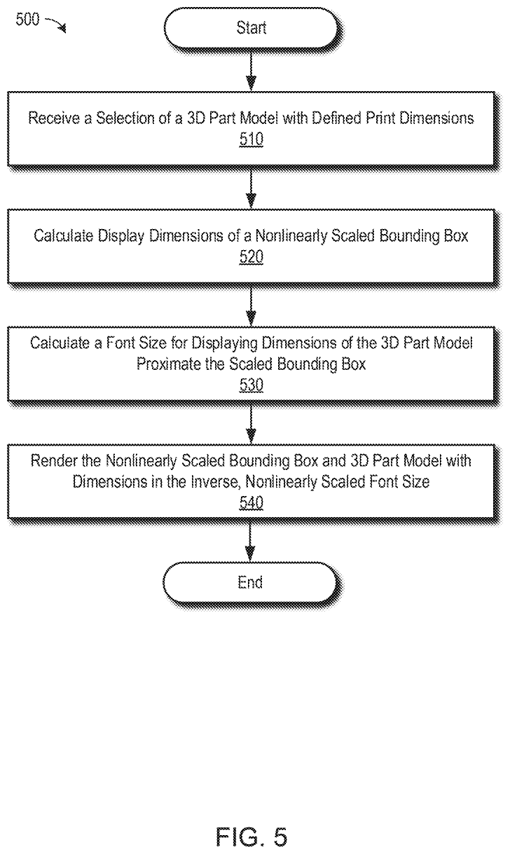

FIG. 5 illustrates a flow chart of an example method 500 for rendering a 3D part with a nonlinearly scaled bounding box and with inverse, nonlinearly scaled font sizes. A system may receive, at 510, a selection of a 3D part model with defined print dimensions. As described herein, the system may calculate, at 520, display dimensions of a nonlinearly scaled bounding box. The system may calculate, at 530, a font size for displaying print dimensions of the 3D part model proximate the scaled bounding box.

The system may render, at 540, for display on an electronic display, the nonlinearly scaled bounding box and 3D part model with print dimensions in the inverse, nonlinear font size. The rendered nonlinearly scaled bounding box and the print dimensions in the inverse, nonlinear font size provide visual context for the size of the 3D part model. With respect to the font size used, relatively large fonts are used proximate smaller 3D part models, while relatively small fonts are used proximate larger 3D part models. In some examples, such as examples using the inverse nonlinear function illustrated in FIG. 4, a constant or nearly constant (e.g., linear) font size may be used for 3D part models within the print size range of an associated 3D printer.

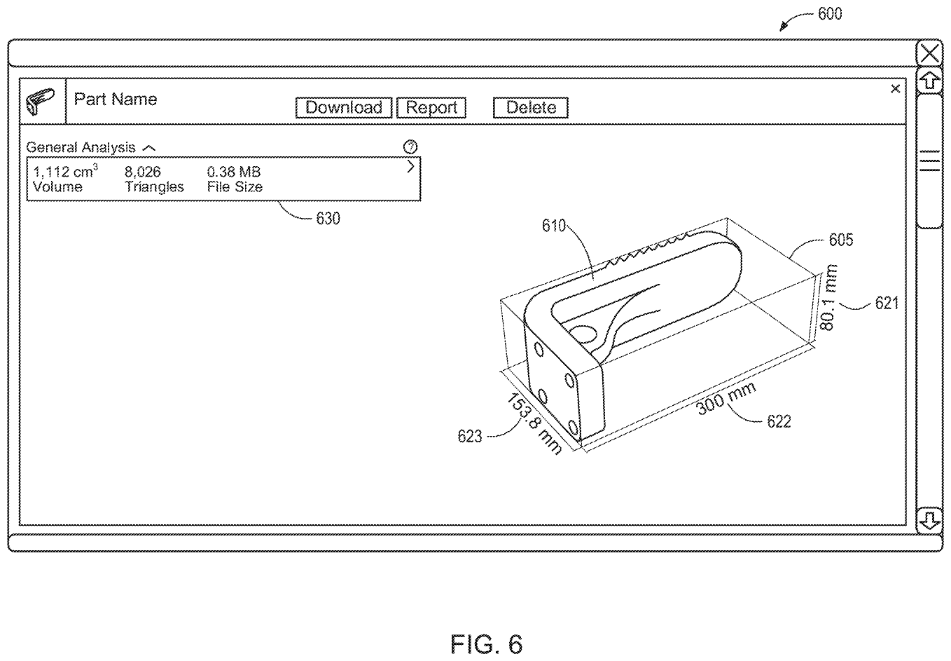

FIG. 6 illustrates an example graphical user interface rendered within a browser window 600 to display a two-dimensional perspective view 610 of a relatively large 3D part model which is printable on a 3D printer. As illustrated, a bounding box 605 is illustrated with display dimensions that are nonlinearly calculated based on the print dimensions of the 3D part model. The part model is near the maximum possible printable size, and so is consuming much of the usable display. The print dimensions (illustrated as height 621, length 622, and depth 623) are displayed in a normal or average font size.

In the illustrated example, the graphical user interface within the browser window 600 includes a model display region within which the bounding box 605 is rendered and an informational region 630 that specifies details of the displayed 3D part model.

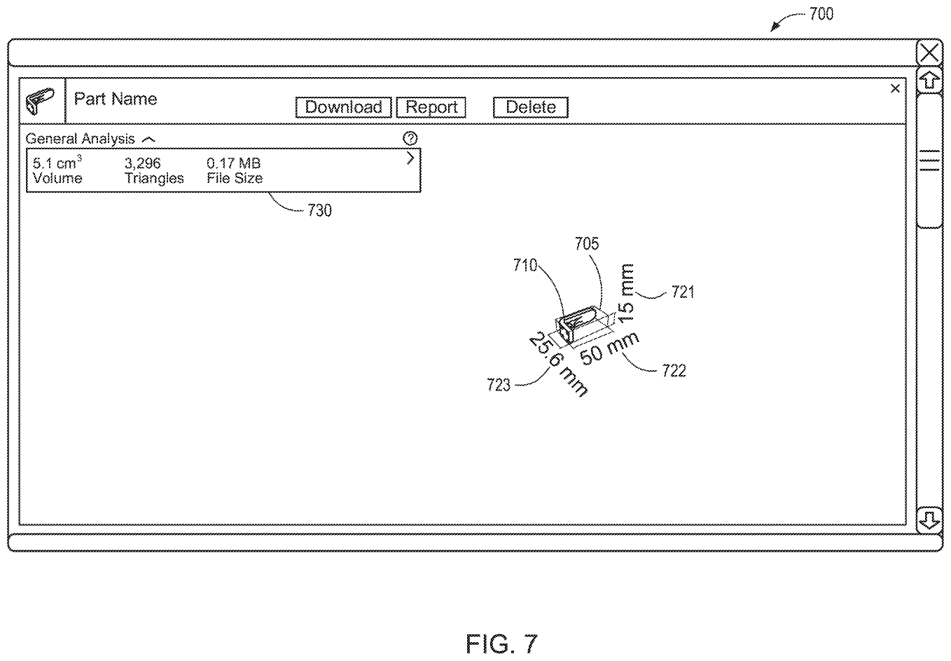

FIG. 7 illustrates an example graphical user interface rendered within a browser window 700 to display a two-dimensional perspective view 710 of a relatively small 3D part model. As illustrated, a bounding box 705 is illustrated with display dimensions that are nonlinearly calculated based on the print dimensions of the 3D part model. The print dimensions (illustrated as height 721, length 722, and depth 723) are displayed in a font size inversely related to the actual print dimensions of the 3D part model.

In the illustrated example, the font size used for the print dimensions is relatively large (as compared with FIG. 6) to make it visually apparent that the 3D part model is smaller. In the illustrated example, the graphical user interface within the browser window 700 includes a model display region within which the bounding box 705 is rendered and an informational region 730 that specifies details of the displayed 3D part model.

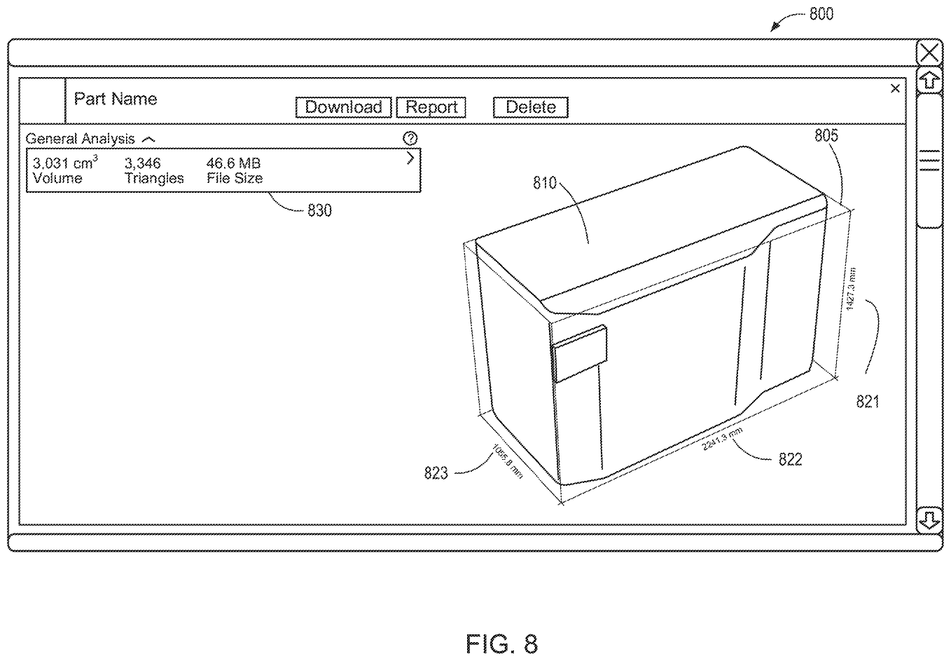

FIG. 8 illustrates an example graphical user interface rendered within a browser window 800 to display a two-dimensional perspective view 810 of an oversized 3D part model (e.g., a 3D part model that exceeds the print size capabilities of an associated 3D printer). As illustrated, a bounding box 805 is illustrated with display dimensions that are nonlinearly calculated based on the print dimensions of the 3D part model. The print dimensions (illustrated as height 821, length 822, and depth 823) are displayed in a font size inversely related to the actual print dimensions of the 3D part model.

In the illustrated example, the font size used for the print dimensions is much smaller (as compared with FIGS. 6 and 7) to make it visually apparent that the 3D part model is large. In the illustrated example, the graphical user interface within the browser window 800 includes a model display region within which the bounding box 805 is rendered and an informational region 830 that specifies details of the displayed 3D part model.

While specific examples and applications of the systems and methods described herein are illustrated and described in detail, the disclosure is not limited to the precise configurations and components as described. Many changes may be made to the details of the above-described examples without departing from the underlying principles of this disclosure. The scope of the present disclosure should, therefore, be understood to encompass at least the following claims.

What is claimed is:

1. A non-transitory computer-readable medium with instructions stored thereon that, when executed by a processor, implement operations to:
calculate display dimensions for a nonlinearly scaled bounding box for a three-dimensional (3D) part model, wherein the display dimensions of the nonlinearly scaled bounding box are calculated as a nonlinear function of print dimensions of the 3D part model scaled to fit within a model display region of a graphical user interface, wherein the non-linear function is based in part on a typical minimum print size or a typical maximum print size of 3D parts printed using an associated 3D printer; and
render, for display in the model display region of the graphical user interface on an electronic display, a two-dimensional view of the 3D part model within the nonlinearly scaled bounding box.

2. The non-transitory computer-readable medium of claim 1, wherein the two-dimensional view of the 3D part model comprises a perspective view of the 3D part model at an angle corresponding to an estimated viewing angle of an operator of a 3D printer viewing the 3D part model printed on a print bed of the 3D printer.

3. The non-transitory computer-readable medium of claim 1, further comprising additional instructions that, when executed by the processor, implement operations to calculate the dimensions of the nonlinearly scaled bounding box:
as a nonlinear function of print dimensions for print dimensions of 3D part models that exceed the typical maximum print size,
as a nonlinear function of print dimensions for print dimensions of 3D part models that are less than the typical minimum print size, and
as an approximately linear function of print dimensions for print dimensions of 3D part models between the typical minimum and maximum print sizes.

4. The non-transitory computer-readable medium of claim 3, wherein the typical minimum print size is equal to a largest print size that is smaller than 90 percent of 3D parts printed using the associated 3D printer, and
wherein the maximum print size is equal to a smallest print size that is larger than 90 percent of 3D parts printed using the associated 3D printer.

5. The non-transitory computer-readable medium of claim 1, further comprising additional instructions that, when executed by the processor, implement operations to:
select a font size that is inversely related to the print dimensions of the 3D part model, such that relatively smaller font sizes are selected for 3D part models having relatively larger print dimensions and relatively larger font sizes are used with 3D part models having relatively smaller print dimensions; and
render, for display on the electronic display proximate the nonlinearly scaled bounding box, the print dimensions of the 3D part model using the selected font size.

6. The non-transitory computer-readable medium of claim 5, further comprising additional instructions that, when executed by the processor, implement operations to select the font size to:
be linear for 3D part models having print dimensions between the typical minimum print size and the typical maximum print size,
nonlinearly approach a minimum font size for 3D part models having print dimensions that exceed the typical maximum print size, and
nonlinearly approach a maximum font size for 3D part models having print dimensions that are less than the typical minimum print size.

7. A method, comprising:
receiving a selection of a three-dimensional (3D) part model with defined print dimensions;
calculating, via a processor, display dimensions of a nonlinearly scaled bounding box as a nonlinear function of the defined print dimensions to be displayed within a model display region of a graphical user interface proximate a perspective view of the 3D part model,
wherein the non-linear function is based on an experienced typical minimum print size or an experienced typical maximum print size of 3D parts printed using an associated 3D printer; and
rendering, for display in the model display region of the graphical user interface on an electronic display, the nonlinearly scaled bounding box proximate the perspective view of the 3D part model.

8. The method of claim 7, wherein the perspective view of the 3D part model is at an angle corresponding to an estimated viewing angle of an operator of a 3D printer viewing the 3D part model printed on a print bed of the 3D printer.

9. The method of claim 7, wherein the display dimensions of the nonlinearly scaled bounding box are calculated:
as a nonlinear function of defined print dimensions that exceed the experienced typical maximum print size,
as a nonlinear function of defined print dimensions that are less than the experienced typical minimum print size, and
as an approximately linear function of defined print dimensions between the experienced typical minimum print size and the typical maximum print size.

10. The method of claim 9, wherein the experienced typical minimum print size is computed from a size of a smallest part previously printed by an associated 3D printer, and
wherein the experienced typical maximum print size is computed from a largest part previously printed by the associated 3D printer.

11. The method of claim 7, further comprising:
selecting, via the processor, a font size that is inversely related to the defined print dimensions of the 3D part model, such that relatively smaller font sizes are selected for 3D part models having relatively larger defined print dimensions and relatively larger font sizes are selected for 3D part models having relatively smaller defined print dimensions; and
rendering, for display on the electronic display proximate the nonlinearly scaled bounding box, the defined print dimensions of the 3D part model using the selected font size.

12. The method of claim 11, wherein the font size is selected to:
be linear for 3D part models having defined print dimensions between the experienced typical minimum print size and the experienced typical maximum print size,
nonlinearly approach a minimum font size for 3D part models having defined print dimensions that exceed the experienced typical maximum print size, and
nonlinearly approach a maximum font size for 3D part models having defined print dimensions that are less than the experienced typical minimum print size.

13. The method of claim 12, wherein the experienced typical minimum print size is equal to a largest print size that is smaller than 80 percent of 3D parts printed using the associated 3D printer, and
wherein the experienced typical maximum print size is equal to a smallest print size that is larger than 80 percent of 3D parts printed using the associated 3D printer

14. A system, comprising:
a processor; and
a non-transitory computer-readable medium with instructions stored thereon that, when executed by the processor, implement operations to:
calculate display dimensions of a nonlinearly scaled bounding box as a nonlinear function of print dimensions of a 3D part model scaled to fit within a model display region of a graphical user interface;
select a font size that is inversely related to the print dimensions of the 3D part model, such that relatively smaller font sizes are used with 3D part models having relatively larger print dimensions and relatively larger font sizes are used with 3D part models having relatively smaller print dimensions; and
render, for display on the model display region of the graphical user interface on an electronic display, a two-dimensional view of the 3D part model within the nonlinearly scaled bounding box with the print dimensions of the 3D part model in the selected font size.

15. The system of claim 14, wherein the display dimensions of the nonlinearly scaled bounding box are calculated:
as a nonlinear function of print dimensions for 3D part models having print dimensions that exceed a maximum print size,
as a nonlinear function of print dimensions for 3D part models having print dimensions that are less than a minimum print size, and
as an approximately linear function of print dimensions for 3D part models having print dimensions between the minimum print size and the maximum print size.
